(19) United States
(12) Patent Application Publication
(10) Pub. No.: US 2022/0263205 A1
(43) Pub. Date: Aug. 18, 2022

(54) BATTERY

(71) Applicant: Panasonic Intellectual Property Management Co., Ltd., Osaka (JP)

(72) Inventors: YUSUKE ITO, Nara (JP); EIICHI KOGA, Osaka (JP)

(21) Appl. No.: 17/661,711

(22) Filed: May 2, 2022

Related U.S. Application Data
(63) Continuation of application No. PCT/JP2020/040474, filed on Oct. 28, 2020.

(30) Foreign Application Priority Data
Nov. 29, 2019 (JP) 2019-216585

(51) Int. Cl. H01M 50/553

(52) U.S. Cl. CPC H01M 50/553

(57) ABSTRACT

A battery of the present disclosure includes: a power generation element that includes a positive electrode layer, a negative electrode layer, and an electrolyte layer which are laminated; and a support that supports the power generation element. The power generation element includes: a first plane that is a plane parallel to a laminating direction of the positive electrode layer, the negative electrode layer, and the electrolyte layer; and a second plane that is a plane perpendicular to the laminating direction, and the support includes: a first support body that is in contact with the first plane; and a second support body that includes a bent part which applies an elastic force to the power generation element in a direction perpendicular to the second plane.

### BACKGROUND

### 1. Technical Field

The present disclosure relates to a battery.

### 2. Description of the Related Art

Japanese Unexamined Patent Application Publication No. 2016-170941 (hereinafter referred to as Patent Document 1) discloses a connection member for connecting a power generation element that includes a positive electrode, a negative electrode, and an electrolyte. The connection member includes a flat plate part and a bent part, and a bottom surface part of the power generation element is in contact with the flat plate part of the connection member.

### SUMMARY

One non-limiting and exemplary embodiment provides a battery with high reliability.

One non-limiting and exemplary embodiment of the present disclosure provides the following battery.

In one general aspect, the techniques disclosed here feature a battery including a power generation element that includes a positive electrode layer, a negative electrode layer, and an electrolyte layer which are laminated; and a support that supports the power generation element, in which the power generation element includes: a first plane that is a plane parallel to a laminating direction of the positive electrode layer, the negative electrode layer, and the electrolyte layer; and a second plane that is a plane perpendicular to the laminating direction, and the support includes: a first support body that is in contact with the first plane; and a second support body that includes a bent part which applies an elastic force to the power generation element in a direction perpendicular to the second plane.

The present disclosure can provide a battery with high reliability.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a perspective view illustrating a schematic configuration of a battery according to an embodiment;

FIG. 2 is a sectional view illustrating a section of a power generation element taken along line II-II in FIG. 1;

FIG. 3A is a side view illustrating a state in which the battery according to the embodiment is housed in a housing;

FIG. 3B is a side view illustrating a state in which a battery of a comparative example is housed in a housing;

FIG. 4A illustrates side views of surrounding parts of second support bodies provided to batteries according to first to third modified examples of the embodiment;

FIG. 4B illustrates side views of surrounding parts of second support bodies provided to batteries according to fourth to sixth modified examples of the embodiment; and

FIG. 5 is a side view illustrating a state in which a battery according to a seventh modified example of the embodiment is housed in a housing.

### DETAILED DESCRIPTION

### (Underlying Knowledge Forming Basis of Present Disclosure)

The inventors of the present disclosure have found out that the following problems arise from the technique according to Patent Document 1 discussed earlier in the

### Description of the Related Art.

First of all, perspectives of the inventors of the present disclosure will be described below. A deterioration in reliability due to factors such as a change in volume of the power generation element associated with power charge and discharge is cited as a problem of the existing battery.

A battery including a solid electrolyte will be described as an example. Specifically, the battery includes a power generation element, and the power generation element includes solid electrolytes and electrode active materials which are laminated. This battery is an all-solid-state battery, for instance. In the meantime, since components (namely, the solid electrolytes and the electrode active materials) of this battery are solid materials, an interface between each electrode active material and the corresponding solid electrolyte is a solid to solid interface.

In general, an all-solid-state battery is formed by carrying out pressure forming. Depending on pressure forming conditions, grains (the grains stated herein refer to electrode active material grains and/or solid electrolyte grains) are insufficiently bonded to one another, and charge and discharge reactions in the power generation element may therefore progress unevenly. In the meantime, since the electrode active materials expand and contract along with the charge and discharge, a stress may be generated throughout the interior of the power generation element if many electrode active material grains having different charge and discharge depths are present. Propagation of such a stress to the entire power generation element may lead to detachment between the electrode active materials and the solid electrolytes or development of fine cracks in the electrode active materials and the solid electrolytes. As a consequence, ion conduction or electron conduction paths may be interrupted and battery characteristics may be significantly deteriorated.

Meanwhile, it has been known that the stress attributed to the expansion of the electrode active materials (that is, the stress attributed to the expansion of the power generation element) is mainly applied in a direction of laminating the solid electrolytes and the electrode active materials. Accordingly, surfaces (such as a top surface and a bottom surface) of the power generation element which are perpendicular to the laminating direction and opposed to each other are susceptible to the stress attributed to the expansion of the power generation element and are prone to outward deformation from the power generation element.

In the meantime, the battery needs to be supported so as to be embedded in a housing or the like. For example, according to Patent Document 1, the power generation element (the battery) is supported by the connection member. To be more precise, the connection member supports the power generation element in such a way as to tuck away the opposed surfaces (which are a negative can bottom surface part and a positive can bottom surface part according to Patent Document 1) of the power generation element.

In this regard, when the above-mentioned expanding power generation element (the battery) is supported in a tucked manner by the connection member, a pressure for supporting the power generation element may be generated in a direction opposite to the stress attributed to the expansion (that is, in a direction to suppress the expansion of the power generation element). In this case, if the power generation element starts expanding, the stress attributed to the expansion of the power generation element presses against the connection member. Hence, the pressure for supporting the power generation element is increased by being pushed back by the connecting member. In other words, a force required for suppressing the expansion of the power generation element is increased, and the power generation element is more likely to develop detachment or cracks therein.

As a consequence, the battery characteristics are significantly deteriorated. Such a battery has low reliability.

To solve the above-described problem, a battery according to an aspect of the present disclosure is a battery that includes a power generation element that includes a positive electrode layer, a negative electrode layer, and an electrolyte layer which are laminated; and a support that supports the power generation element, in which the power generation element includes: a first plane that is a plane parallel to a laminating direction of the positive electrode layer, the negative electrode layer, and the electrolyte layer; and a second plane that is a plane perpendicular to the laminating direction, and the support includes: a first support body that is in contact with the first plane; and a second support body that includes a bent part which applies an elastic force to the power generation element in a direction perpendicular to the second plane.

Accordingly, the first support body is in contact with and supports the first plane. The first plane extends parallel to the laminating direction, and is therefore less susceptible to a stress attributed to expansion of the power generation element and less prone to deformation. Since the first support body is in contact with and supports the above-described first plane, the support can easily support the power generation element.

In the meantime, the stress attributed to the expansion of the power generation element is mainly applied in the laminating direction. Similarly, the bent part can apply the elastic force in the laminating direction. By providing the bent part as described above, it is less likely to increase the pressure for supporting the power generation element even when the power generation element expands. Thus, it is possible to suppress the occurrence of detachment or cracks in the power generation element.

In other words, provision of the support makes it possible to support the power generation element easily and to suppress the occurrence of detachment or cracks in the power generation element. As a consequence, the battery with high reliability is obtained.

The support may be an electrode terminal, and the support is coupled to one of the positive electrode layer and the negative electrode layer.

Accordingly, an individual electrode is not required since the support supports the power generation element and is electrically coupled to the power generation element. As a consequence, it is possible to suppress an increase in size of the battery.

The second support body may further include a parallel surface that extends parallel to and along the second plane, and the parallel surface is in contact with the second plane.

Accordingly, in addition to the support of the first plane by the first support body, the parallel surface supports the second plane, so that the support can support the power generation element more easily.

The second support body may be separated from the second plane.

Accordingly, even when the power generation element expands, the second plane of the power generation element does not come into contact with the second support body and the second plane is kept from receiving any pressure from the second support body. Thus, it is possible to suppress the occurrence of detachment or cracks in the power generation element.

The battery may further include a resin member located between the second support body and the second plane.

Accordingly, the second support body supports the second plane through the resin member in addition to the support of the first plane by the first support body. Thus, the support can support the power generation element more easily.

The first support body may be in contact with an entire surface of the first plane.

Accordingly, the support can support the power generation element more easily by increasing the contact area between the support and the power generation element.

The support may project from the second plane in a direction perpendicular to the second plane in an amount greater than or equal to 1 mm and less than or equal to 10 mm.

Accordingly, by setting the projection distance greater than or equal to 1 mm, a sufficient space is ensured around the power generation element. In this way, even when the power generation element expands, the second plane of the power generation element is kept from being in contact with a surrounding object and receiving any pressure from the surrounding object. Thus, it is possible to suppress the occurrence of detachment or cracks in the power generation element.

Meanwhile, by setting the projection distance less than or equal to 10 mm, it is possible to reduce an unnecessary space around the power generation element. Thus, it is possible to suppress an increase in size of the battery.

The support may project from the first plane in a direction opposite to the power generation element in an amount greater than or equal to 0.1 mm and less than or equal to 10 mm.

As described above, the power generation element is deformed mainly in the laminating direction. Nonetheless, the power generation element is slightly deformed in a direction perpendicular to the laminating direction as well. In this regard, even when the power generation element is deformed in such a way as to extend in the direction perpendicular to the laminating direction (such as a direction opposite to the power generation element from the first plane), the deformation of the power generation element in the perpendicular direction is allowed by setting the distance of projection in the direction perpendicular to the laminating direction greater than or equal to 0.1 mm. As a consequence, the deformation of the power generation element is relaxed and reliability of the battery is improved.

In the meantime, it is possible to embed the battery in a smaller region by further reducing the projection distance. For this reason, an increase in size of the battery is suppressed by setting the projection distance less than or equal to 10 mm.

The support may be formed from a plate member having a thickness greater than or equal to 50 μm and less than or equal to 5000 μm.

Accordingly, a mechanical strength of the support is improved when the thickness is greater than or equal to 50 μm. When the thickness is less than or equal to 5000 μm, it is easily to form the bent part in the support.

The electrolyte layer may be a solid electrolyte layer.

Accordingly, it is possible to improve reliability of the all-solid-state battery including the solid electrolyte.

The power generation element may include a plurality of battery cells which are laminated, and each of the battery cells includes the positive electrode layer, the negative electrode layer, and the electrolyte layer.

Accordingly, it is possible to increase a voltage or a capacity of the battery by laminating the multiple battery cells, thereby improving reliability of the battery.

A sectional shape of the bent part taken along a plane perpendicular to the first plane and to the second plane may include one of a U-shape, a V-shape, and an L-shape.

Accordingly, since the bent part includes any of the above-mentioned shapes, the bent part can exert a sufficient elastic force.

Embodiments of a battery according to the present disclosure will be described below with reference to the drawings.

It is to be noted that each embodiment described below is intended to demonstrate one specific preferred example. Therefore, numerical values, shapes, materials, constituents, layouts and modes of coupling the constituents and so forth described in the following embodiments are mere examples and are not intended to limit the scope of the present disclosure. In this regard, among the constituents of the following embodiments, the constituents that are not stated in an independent claim to define a dominant conception will be described as optional constituents. In the meantime, the respective drawings are merely schematic and are not necessarily intended to precisely illustrate the embodiments. In addition, in the respective drawings, the same constituent members are denoted by the same reference numerals.

Meanwhile, various elements illustrated in the drawings are merely schematic and dimensional ratios, external appearances, and other features thereof may be different from reality. In other words, the respective drawings are schematic diagrams which do not necessarily illustrate precise features. As a consequence, scales and other factors do not necessarily coincide with one another between the drawings, for instance. In addition, each numerical range in this specification is not an expression that represents strict meanings only, but is rather an expression that also signifies a substantially equivalent range that may include allowances of several percent, for example.

Moreover, in the description concerning a certain structure in this specification, a term “upper” or “lower” does not necessarily indicate an upper direction (vertically upward) or a lower direction (vertically downward) in terms of absolute space recognition, but is used as a term to be defined by a relative positional relation based on the laminating order in a laminating structure.

In the following description, lithium may be expressed as Li, sulfur may be expressed as S, phosphorus may be expressed as P, silicon may be expressed as Si, boron may be expressed as B, germanium may be expressed as Ge, fluorine may be expressed as F, chlorine may be expressed as Cl, bromine may be expressed as Br, iodine may be expressed as I, oxygen may be expressed as O, aluminum may be expressed as Al, gallium may be expressed as Ga, indium may be expressed as In, iron may be expressed as Fe, zinc may be expressed as Zn, titanium may be expressed as Ti, lanthanum may be expressed as La, zirconium may be expressed as Zr, nitrogen may be expressed as N, hydrogen may be expressed as H, arsenic may be expressed as As, antimony may be expressed as Sb, tellurium may be expressed as Te, carbon may be expressed as C, selenium may be expressed as Se, yttrium may be expressed as Y, and magnesium may be expressed as Mg when appropriate.

### Embodiment

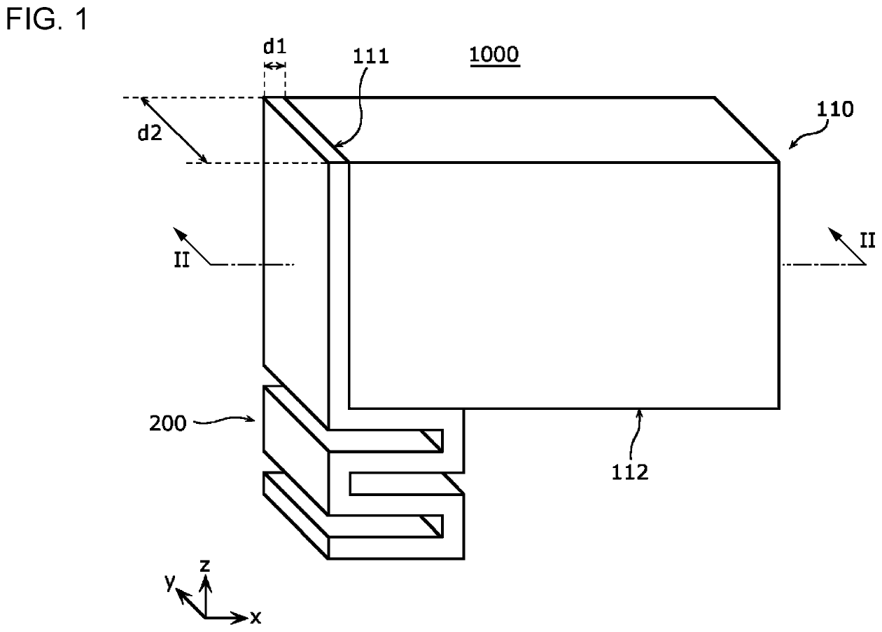

A battery 1000 according to an embodiment of the present disclosure will be described with reference to FIGS. 1 to 3B.

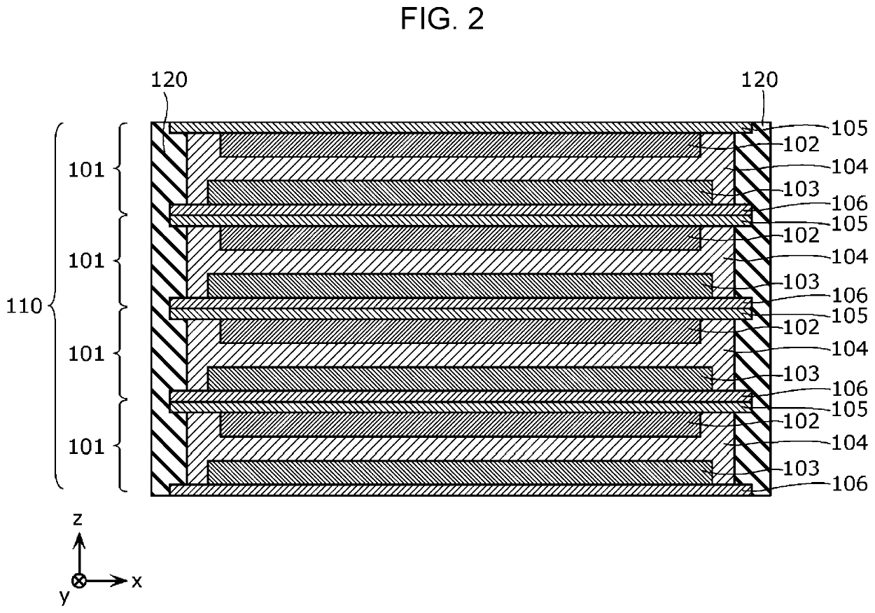

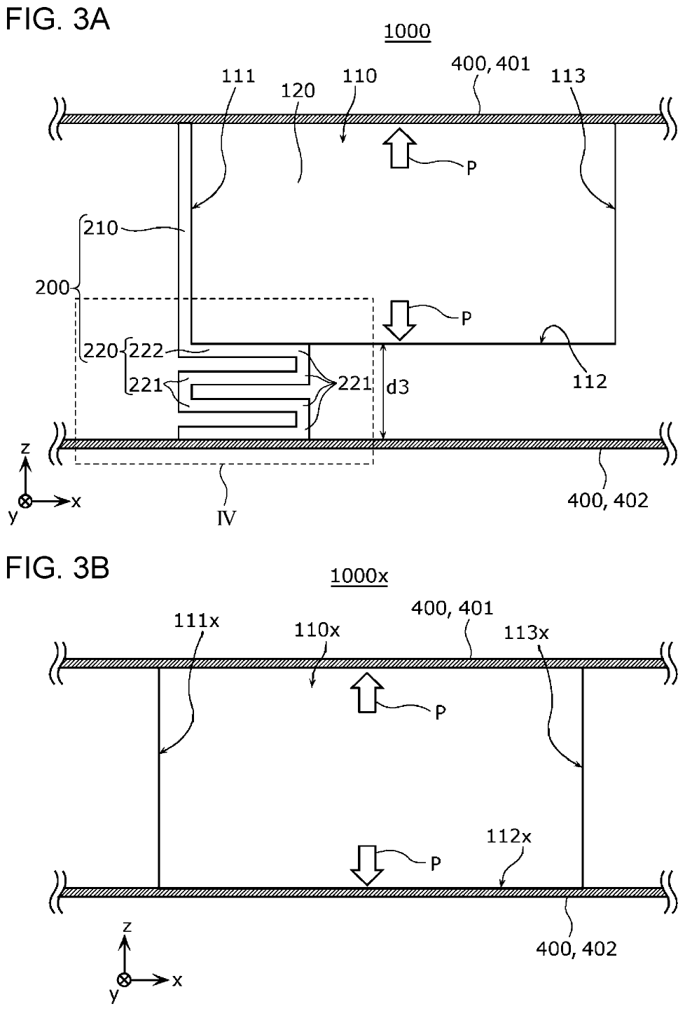

FIG. 1 is a perspective view showing a schematic configuration of the battery 1000 of this embodiment. FIG. 2 is a sectional view illustrating a section of a power generation element 110 taken along line II-II in FIG. 1. FIG. 3A is a side view illustrating a state in which the battery 1000 according to the embodiment is housed in a housing 400. FIG. 3B is a side view illustrating a state in which a battery 1000x of a comparative example is housed in the housing 400.

The battery 1000 of this embodiment includes the power generation element 110 and a support 200. The battery 1000 of this embodiment is housed in the housing (see FIG. 3A).

First, the power generation element 110 will be described with reference to FIGS. 1 and 2.

The power generation element 110 includes multiple battery cells 101 that are laminated, and insulators 120. Each of the multiple battery cells 101 includes a positive electrode layer, a negative electrode layer, and an electrolyte layer. Accordingly, the power generation element 110 includes the positive electrode layers, the negative electrode layers, and the electrolyte layers which are laminated. In this embodiment, the positive electrode layer includes a positive electrode 102 and a positive electrode current collector 105, the negative electrode layer includes a negative electrode 103 and a negative electrode current collector 106, and the electrolyte layer is a solid electrolyte layer 104.

A shape of the power generation element 110 in plan view (that is, a shape of the power generation element 110 when viewed in the negative direction of the Z-axis) is a rectangle. However, the present disclosure is not limited to this configuration. An area of a principal surface of the power generation element 110 (a surface recognized in plan view) may be set greater than or equal to 1 cm² and less than or equal to 1000 cm², for example.

The positive electrode 102 is a layer that contains a positive electrode active material. The positive electrode 102 may be a positive electrode mixture layer that contains the positive electrode active material and a solid electrolyte.

Usable examples of the positive electrode active material contained in the positive electrode 102 include lithium-containing transition metal oxides, transition metal fluorides, polyanionic materials, fluorinated polyanionic materials, transition metal sulfides, transition metal oxyfluorides, transition metal oxysulfides, transition metal oxynitrides, and the like. It is possible to reduce manufacturing costs and to increase an average discharge voltage especially when a lithium-containing transition metal oxide is used as the positive electrode active material.

Meanwhile, such a positive electrode active material may have a granular shape. In this case, a median size of the positive electrode active material grains may be greater than or equal to 0.1 μm and less than or equal to 100 μm. If the median size of the positive electrode active material grains is less than 0.1 μm, the positive electrode active material grains and the solid electrolyte may fail to establish a favorable state of dispersion in the positive electrode 102, whereby the charge and discharge performances of the battery may be deteriorated. On the other hand, if the median size of the positive electrode active material grains is more than 100 μm, ionic diffusion in the positive electrode active material grains slows down, whereby it may be difficult to operate the battery at high output. The median size of the positive electrode active material grains may be larger than a median size of the solid electrolyte grains. In this way, a favorable state of dispersion of the positive electrode active material and the solid electrolyte is established.

A thickness of the positive electrode 102 (that is, a length in the direction of the Z-axis) may be set in a range from 10 to 500 μm. If the thickness of the positive electrode 102 is less than 10 μm, it may be difficult to ensure a sufficient energy density of the battery. On the other hand, if the thickness of the positive electrode 102 is more than 500 μm, it may be difficult to operate the battery at high output.

A porous or non-porous sheet or film made of a metal material such as aluminum, stainless steel, titanium, and an alloy of any of these metals may be used as the positive electrode current collector 105. Aluminum or an aluminum alloy is low in cost and easily formed into a thin film. The sheet or film may be a metal foil, a mesh sheet, or the like. A thickness of the positive electrode current collector 105 may be set in a range from 1 to 30 μm. If the thickness of the positive electrode current collector 105 is less than 1 μm, the positive electrode current collector 105 is prone to cracking or tearing due to having insufficient mechanical strength. On the other hand, if the thickness of the positive electrode current collector 105 is more than 30 μm, the energy density of the battery may be reduced.

The negative electrode 103 is a layer that contains a negative electrode active material. The negative electrode 103 may be a negative electrode mixture layer that contains the negative electrode active material and the solid electrolyte.

The negative electrode active material contained in the negative electrode 103 may be a material that stores and releases metal ions, for example. The negative electrode active material may be a material that stores and releases lithium ions, for instance. Usable examples of the negative electrode active material include lithium metal, metals or alloys that undergo an alloying reaction with lithium, carbon, transition metal oxides, transition metal sulfides, and the like. Usable examples of the metal or the alloy that undergoes an alloying reaction with lithium include alloys of lithium and any of silicon compounds, tin compounds, aluminum compounds, and the like. As for carbon, either graphite or non-graphite carbon such as hard carbon and coke may be used, for example. Meanwhile, any of copper oxide (CuO), nickel oxide (NiO), and the like may be used as a transition metal oxide, for example. Copper sulfide represented by CuS may be used as a transition metal sulfide, for example. It is possible to reduce manufacturing costs and to increase the average discharge voltage especially when carbon is used as the negative electrode active material. In light of the capacity density, any of silicon (Si), tin (Sn), a silicon compound, and a tin compound is suitably used as the negative electrode active material.

Meanwhile, such a negative electrode active material may have a granular shape. In this case, a median size of the negative electrode active material grains may be greater than or equal to 0.1 μm and less than or equal to 100 μm. If the median size of the negative electrode active material grains is less than 0.1 μm, the negative electrode active material grains and the solid electrolyte may fail to establish a favorable state of dispersion in the negative electrode 103, whereby the charge and discharge performances of the battery may be deteriorated. On the other hand, if the median size of the negative electrode active material grains is more than 100 μm, lithium diffusion in the negative electrode active material grains slows down, whereby it may be difficult to operate the battery at high output. The median size of the negative electrode active material grains may be larger than the median size of the solid electrolyte grains. In this way, a favorable state of dispersion of the negative electrode active material and the solid electrolyte is established.

A thickness of the negative electrode 103 may be set in a range from 10 to 500 μm. If the thickness of the negative electrode 103 is less than 10 μm, it may be difficult to ensure the sufficient energy density of the battery. On the other hand, if the thickness of the negative electrode 103 is more than 500 μm, it may be difficult to operate the battery at high output.

A porous or non-porous sheet or film made of a metal material such as stainless steel, nickel, copper, and an alloy of any of these metals may be used as the negative electrode current collector 106. Copper or a copper alloy is low in cost and easily formed into a thin film. The sheet or film may be a metal foil, a mesh sheet, or the like. A thickness of the negative electrode current collector 106 may be set in a range from 1 to 30 μm. If the thickness of the negative electrode current collector 106 is less than 1 μm, the negative electrode current collector 106 is prone to cracking or tearing due to having insufficient mechanical strength. On the other hand, if the thickness of the negative electrode current collector 106 is more than 30 μm, the energy density of the battery may be reduced.

The solid electrolyte layer 104 contains the solid electrolyte.

A thickness of the solid electrolyte layer 104 may be set in a range from 1 to 200 μm. If the thickness of the solid electrolyte layer 104 is less than 1 μm, the positive electrode 102 and the negative electrode 103 are more likely to short-circuit. On the other hand, if the thickness of the solid electrolyte layer 104 is more than 200 μm, it may be difficult to operate the battery at high output.

For example, any of sulfide solid electrolytes, oxide solid electrolytes, halide solid electrolytes, polymer solid electrolytes, complex hydride solid electrolytes, and the like may be used as the solid electrolytes contained in the positive electrode 102, the negative electrode 103, and the solid electrolyte layer 104. The respective solid electrolytes contained in the positive electrode 102, the negative electrode 103, and the solid electrolyte layer 104 may be made of different materials from one another.

Usable examples of the sulfide solid electrolyte include Li₂S—P₂S₅, Li₂S—SiS₂, Li₂S—B₂S₃, Li₂S—GeS₂, Li₃₂₅Ge_{0.25}P_{0.75}S₄, Li₁₀GeP₂S₁₂, and the like. Meanwhile, any of LiX (where X is any of F, Cl, Br, and I), Li₂O, MOp, LiqMOr, (where M is any of P, Si, Ge, B, Al, Ga, In, Fe, and Zn, and each of p, q, and r is a natural number), and the like may be added to any of these sulfide solid electrolytes.

Usable examples of the oxide solid electrolyte include NASICON (Na super ionic conductor) solid electrolytes typified by LiTi₂(PO₄)₃ and element-substituted derivatives thereof, (LaLi)TiO₃-based perovskite solid electrolytes, LISICON (lithium super ionic conductor) solid electrolytes typified by Li₁₄ZnGe₄O₁₆, Li₄SiO₄, LiGeO₄, and element-substituted derivatives thereof, garnet solid electrolytes typified by Li₇La₃Zr₂O₁₂ and element-substituted derivatives thereof, Li₃N and H-substituted derivatives thereof, Li₃PO₄ and N-substituted derivatives thereof, and a glass or glass ceramic based on a Li—B—O compound such as LiBO₂ and Li₃BO₃ with addition of Li₂SO₄, Li₂CO₃, or the like.

A usable example of the halide solid electrolytes is a material expressed by a composition formula Li_{α}M_{β}X_{γ}, where each of α, β and γ is a value larger than 0, M includes at least one of metalloid elements or metal elements other than Li, and X is one or more elements selected from the group consisting of Cl, Br, I and F. Here, the metalloid elements are B, Si, Ge, As, Sb, and Te. The metal elements are all the elements included in groups 1 to 12 of the periodic table except hydrogen, and all the elements included in groups 13 to 16 of the periodic table except C, N, P, O, S, Se, and the metalloid elements cited above. In other words, the metal element is one of the group of elements that may serve as a cation when the metal element and a halide compound are formed into an inorganic compound. Usable examples of the halide solid electrolyte include Li₃YX₆, Li₂MgX₄, Li₂FeX₄, LiAX₄, Li₃AX₆, (where A is any of Al, Ga, and In while Xis any of F, Cl, Br, and I), and the like.

A compound of a polymer compound and a lithium salt may be used as the polymer solid electrolyte. The polymer compound may have an ethylene oxide structure. The polymer compound having the ethylene oxide structure can contain a large amount of the lithium salt, thereby increasing ion conductivity. Usable examples of the lithium salt include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), LiC(SO₂CF₃)₃, and the like. Any one of these lithium salts may be used alone. Alternatively, a mixture of two or more lithium salts selected from the aforementioned substances may be used as the lithium salt.

Usable examples of the complex hydride solid electrolyte include LiBH₄—LiI, LiBH₄—P₂S₅, and the like.

In the meantime, such a solid electrolyte may have a granular shape.

At least one of the positive electrode 102, the solid electrolyte layer 104, or the negative electrode 103 may contain a binder for the purpose of improving adhesion between the grains. The binder is used in order to improve the adhesion between the materials constituting the electrode. Usable examples of the binder include polyvinylidene fluoride, polytetrafluoroethylene, polyethylene, polypropylene, aramid resin, polyamide, polyimide, polyamide-imide, polyacrylnitrile, polyacrylic acid, methyl polyacrylate, ethyl polyacrylate, hexyl polyacrylate, polymethacrylic acid, methyl polymethacrylate, ethyl polymethacrylate, hexyl polymethacrylate, polyvinyl acetate, polyvinyl pyrrolidone, polyether, polyethersulfone, hexafluoro-polypropylene, styrene-butadiene rubber, carboxymethyl cellulose, and the like. More usable examples of the binder include copolymers of two or more materials selected from tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. Meanwhile, a mixture of two or more substances selected from the above-mentioned materials may also be used as the binder.

At least one of the positive electrode 102 or the negative electrode 103 may contain a conductive aid for the purpose of improving electron conductivity. Usable examples of the conductive aid include graphites such as natural graphite and artificial graphite, carbon blacks such as acetylene black and Ketjet Black (registered trademark), conductive fibers such as carbon fibers and metal fibers, metal powders of aluminum and the like, conductive whiskers such as zinc oxide and potassium titanate, conductive metal oxides such as titanium oxide, conductive polymer compounds such as polyaniline, polypyrrole, and polythiophene, and the like. The use of the carbon-based conductive aid such as the graphites and the carbon blacks can achieve cost reduction.

The insulator 120 is a layer provided with an insulation property, which covers a surface of the power generation element 110 parallel to the laminating direction. Specifically, the surface of the power generation element 110 parallel to the laminating direction is a surface of the power generation element 110 parallel to the YZ plane and the ZX plane.

The insulation property provided to the insulator 120 is such an insulation property that can electrically insulate the support 200 from the positive electrode layer or the negative electrode layer of the power generation element 110 when the support 200 is an electrode terminal (to be described later in detail).

A typical material constituting the insulator 120 is a resin material. However, the material of the insulator 120 is not limited to a particular material.

Meanwhile, in each battery cell 101, the negative electrode layer (the negative electrode current collector 106 and the negative electrode 103), the electrolyte layer (the solid electrolyte layer 104), and the positive electrode layer (the positive electrode 102 and the positive electrode current collector 105) are laminated in this order as illustrated in FIG. 2. Accordingly, the laminating direction is the direction that extends along the Z-axis.

As illustrated in FIG. 1, the power generation element 110 includes a first plane 111 which is parallel to the laminating direction, and a second plane 112 which is perpendicular to the laminating direction. Since the laminating direction is the direction that extends along the Z-axis, the first plane 111 is a plane that extends parallel to the YZ plane while the second plane 112 is a plane that extends parallel to the XY plane. The power generation element 110 may also have a third plane 113 that faces the first plane 111.

In this embodiment, the first plane 111 and the third plane 113 are planes where the insulator 120 is exposed while the second plane 112 is a plane where the negative electrode current collector 106 included in the negative electrode layer is exposed.

It has been known that the power generation element 110 expands mainly in the laminating direction. As a consequence, the power generation element 110 is deformed in such a way as to extend mainly in the positive direction of the Z-axis and the negative direction of the Z-axis. For this reason, the first plane 111 and the third plane 113 are less susceptible to a stress attributed to the expansion of the power generation element 110 and are less prone to deformation. On the other hand, the second plane 112 is susceptible to the stress attributed to the expansion of the power generation element 110 and is more prone to deformation.

Next, the housing 400 will be described with reference to FIG. 3A. FIG. 3A is a diagram that illustrates a side view of the battery 1000 and a sectional view of the housing 400.

The housing 400 is a container for housing the battery 1000. The housing 400 may house two or more batteries 1000. A shape of the housing 400 is a rectangular parallelepiped having an internal space for housing the battery 1000. However, the shape of the housing 400 is not limited to a particular shape. The housing 400 is made of a metal or a resin. However, the material of the housing 400 is not limited to a particular material.

As illustrated in FIG. 3A, the housing 400 includes a top surface portion 401 and a bottom surface portion 402. The top surface portion 401 is in contact with the power generation element 110. The support 200 is used for embedding the battery 1000 in the internal space of the housing 400.

Next, the support 200 will be described with reference to FIGS. 1 and 3A. Note that arrows P that represent directions of generation of the stress attributed to the expansion of the power generation element 110 are indicated in FIG. 3A.

The support 200 is a member to support the power generation element 110. An adhesive layer, for example, may be provided between the support 200 and the power generation element 110.

The support 200 includes a first support body 210 and a second support body 220.

The first support body 210 is in contact with the first plane 111. To be more precise, the first support body 210 is in contact with and supports the first plane 111. The first support body 210 has a flat plate shape. However, the shape of the first support body 210 is not limited to a particular shape as long as the first support body 210 is configured to be in contact with the first plane 111.

As described above, the first support body 210 is in contact with and supports the first plane 111 that is less susceptible to the stress attributed to the expansion of the power generation element 110 and less prone to deformation. Accordingly, the support 200 can easily support the power generation element 110.

Moreover, the first support body 210 may be in contact with the entire surface of the first plane 111 as illustrated in FIG. 1.

The support 200 can support the power generation element 110 more easily by increasing the contact area between the support 200 and the power generation element 110 as described above.

Here, the first support body 210 may be in contact with part of the first plane 111. For example, a length d2 in the direction of the Y-axis of the first support body 210 may be smaller than a length in the direction of the Y-axis of the power generation element 110.

The second support body 220 may be connected to the bottom surface portion 402 of the housing 400. In other words, the bottom surface portion 402 is a supporting surface serving as a surface to support the battery 1000.

Meanwhile, as a consequence of providing the support 200, the power generation element 110 is in a state of being separated from the supporting surface (the bottom surface portion 402 of the housing).

The second support body 220 includes bent parts 221 and a parallel surface 222.

The parallel surface 222 extends parallel to and along the second plane 112 provided to the power generation element 110, and is in contact with the second plane 112. The parallel surface 222 provided to the second support body 220 may be connected to the first support body 210.

In addition to the first support body 210 supporting the first plane 111 as described above, the parallel surface 222 supports the second plane 112 so that the support 200 can support the power generation element 110 more easily.

Each bent part 221 is a region that applies an elastic force to the power generation element 110 in a direction perpendicular to the second plane 112. In this embodiment, a sectional shape of the bent part 221 taken along a plane perpendicular to the first plane 111 and to the second plane 112 (that is, the ZX plane) includes an L-shape. Since the sectional shape includes an L-shape, the bent part 221 can exert a sufficient elastic force. The second support body 220 may include two or more bent parts 221.

The bent part 221 is a region that has a bent shape in the second support body 220. Examples of the bent shape include a folded shape that does not have any curvature radius and a shape that is curved with a prescribed curvature radius.

When the bent parts 221 each having the sectional shape including the L-shape are provided as illustrated in FIG. 3A, the second support body 220 may include a turned-back shape. In this case, the second support body 220 exhibits a bellows shape which is obtained by forming the turned-back shape while alternating mountain folds and valley folds.

Provision of the second support body 220 with the bent parts 221 as described above makes it possible to apply the elastic force to the power generation element 110 in the direction perpendicular to the second plane 112 (that is, the laminating direction). In this embodiment, the second support body 220 includes the parallel surface 222, and the parallel surface 222 is in contact with the second plane 112. Thus, the bent parts 221 can apply the elastic force to the second plane 112.

Now, a battery 1000x according to a comparative example will be described with reference to FIG. 3B.

The battery 1000x according to the comparative example includes a power generation element 110x but does not include a support. The power generation element 110x has the same configuration as that of the power generation element 110 of this embodiment. The power generation element 110x includes a first plane 111x, a second plane 112x , and a third plane 113x . Moreover, the battery 1000x is housed in the housing 400, and is in contact with and is supported by the top surface portion 401 and the bottom surface portion 402.

When the power generation element 110x in the battery 1000x expands, the power generation element 110x is deformed in such a way as to extend in the positive direction of the Z-axis and the negative direction of the Z-axis. As a consequence, the power generation element 110x is pushed back from the top surface portion 401 and the bottom surface portion 402. In other words, pressures from the top surface portion 401 and the bottom surface portion 402 for supporting the power generation element 110x are increased. As a consequence, the power generation element 110x is more likely to cause detachment or cracks therein. In short, the battery 1000x of the comparative example has low reliability.

The battery 1000 of this embodiment will be described with reference to FIG. 3A again.

As discussed above, the stress attributed to the expansion of the power generation element 110 is mainly applied in the laminating direction. Similarly, the bent parts 221 can apply the elastic force in the laminating direction. By providing the bent parts as described above, it is less likely to increase the pressure for supporting the power generation element 110 even when the power generation element 110 expands. Thus, it is possible to suppress the occurrence of detachment or cracks in the power generation element 110.

In other words, provision of the support 200 makes it possible to support the power generation element 110 easily and to suppress the occurrence of detachment or cracks in the power generation element 110. As a consequence, the battery 1000 with high reliability is obtained.

In addition, the multiple battery cells 101 are laminated in the power generation element 110 as mentioned above.

By laminating the multiple battery cells 101 as described above, it is possible to increase a voltage or a capacity of the battery 1000. On the other hand, in the battery 1000 including the multiple battery cells 101, the thickness of the power generation element 110 is increased more than in a battery including a single battery cell 101. For this reason, the battery 1000 has a higher risk of susceptibility to the deformation such as warpage attributed to generation of the stress in the power generation element 110. Accordingly, it is important to apply a technique for improving reliability to the battery 1000.

The support 200 may project from the second plane 112 in a direction perpendicular to the second plane 112 (which is the negative direction of the Z-axis in this embodiment). To be more precise, a distance d3 of projection of the support 200 from the second plane 112 may be greater than or equal to 1 mm and less than or equal to 10 mm. In other words, the projection distance d3 is a distance between the power generation element 110 and the supporting surface (the bottom surface portion 402 of the housing).

By setting the projection distance d3 greater than or equal to 1 mm as mentioned above, a sufficient space is defined around the power generation element 110 (more specifically, between the power generation element 110 and the supporting surface). In this way, even when the power generation element 110 expands, the second plane 112 of the power generation element 110 is kept from being in contact with a surrounding object (the supporting surface, to be more precise) and receiving any pressure from the surrounding object (the supporting surface, to be more precise). Thus, it is possible to suppress the occurrence of detachment or cracks in the power generation element 110.

By setting the projection distance d3 less than or equal to 10 mm, it is possible to reduce an unnecessary space around the power generation element 110 (more specifically, between the power generation element 110 and the supporting surface). Thus, it is possible to suppress an increase in size of the battery 1000.

A metal or a resin is used as a material constituting the support 200, for example. However, the material is not limited to the foregoing. Usable examples of such a metal include aluminum, stainless steel, titanium, nickel, copper, magnesium, an alloy of any of these metals, and the like. Examples of the resin to be used for constituting the support 200 include epoxy, polyethylene, polypropylene, polystyrene, polyvinyl chloride, acryl, acrylonitrile, polyamide, polyacetal, polycarbonate, polyethylene terephthalate, polybutylene terephthalate, polyurethane, polyphenylene sulfide, polysulfone, polyethersulfone, polyarylate, polyether ether ketone, polyetherimide, polytetrafluoroethylene, perfluoroalkoxy alkane, polychlorotrifluoroethylene, polyvinylidene fluoride, and the like.

The support 200 may be formed from a plate member having a thickness dl greater than or equal to 50 μm and less than or equal to 5000 μm. A mechanical strength of the support 200 is improved when the thickness dl is greater than or equal to 50 μm as mentioned above. When the thickness dl is less than or equal to 5000 μm, it is easily to form the bent parts 221 in the support 200.

The support 200 may be an electrode terminal. The electrode terminal has a role in supplying electric power. In this case, the support 200 is coupled to one of the positive electrode layer and the negative electrode layer. In this embodiment, the second support body 220 included in the support 200 is coupled to the negative electrode current collector 106 included in the negative electrode layer exposed to the second plane 112. When the support 200 is the electrode terminal, the support 200 may be made of any of the aforementioned metals. Moreover, no adhesive layer that may block electric conduction is provided between the support 200 and the power generation element 110 in this case.

As described above, an individual electrode is not required when the support 200 supports the power generation element 110 and is electrically coupled to the power generation element 110. As a consequence, it is possible to suppress an increase in size of the battery.

Meanwhile, when the support 200 is made of a metal, a surface of the support 200 may be covered with a resin. For example, the surface of the support 200 may be coated with the resin. Plasticity originating from the resin increases shock resistance of the power generation element against the deformation, thereby improving adhesion between the first plane 111 and the first support body 210 and facilitating the supporting action. In other words, the resin can provide the battery 1000 with high reliability.

Usable examples of the resin in this case include organic polymers such as polyvinylidene fluoride, polytetrafluoroethylene, polyethylene, polypropylene, aramid resin, polyamide, polyimide, polyamide-imide, polyacrylnitrile, polyacrylic acid, methyl polyacrylate, ethyl polyacrylate, hexyl polyacrylate, polymethacrylic acid, methyl polymethacrylate, ethyl polymethacrylate, hexyl polymethacrylate, polyvinyl acetate, polyvinylpyrrolidone, polyether, polyether sulfone, hexafluoropolypropylene, and carboxymethyl cellulose. Meanwhile, more usable examples thereof include various rubber materials such as silicone rubber, chloroprene rubber, nitrile butadiene rubber, ethylene propylene rubber, chlorosulfonated polyethylene rubber, acrylic rubber, urethane rubber, fluororubber, polysulfide rubber, natural rubber, isoprene rubber, styrene-butadiene rubber, butyl rubber, and butadiene rubber.

Here, the resin at a location where the support 200 serving as the electrode terminal is coupled to the power generation element 110 may be a conductive polymer, for example. An improvement in rate characteristic is expected by causing the resin that covers the support 200 to function as a current collector. Usable examples of the conductive polymer include polyacetylene, polyaniline, polypyrrolle, polythiophene, and the like.

For example, conductive paste of the resin may be used at the location where the support 200 serving as the electrode terminal is coupled to the power generation element 110. Since the resin that covers the support 200 is provided with conductivity and the plasticity intrinsic to the resin increases the shock resistance, it is possible to ensure high reliability of the battery 1000.

Meanwhile, the support 200 serving as the electrode terminal may be coupled to the power generation element 110 by using solder. Line resistance is significantly reduced by coupling of the support 200, the solder, and the power generation element 110, all of which are metal components. Thus, a high rate characteristic is expected. Since the solder also functions as the current collector, it is possible remove or reduce the thickness of the discrete current collector, and thus to reduce the thickness of the power generation element 110. The reduction in thickness of the power generation element 110 makes it possible to improve the energy density of the power generation element 110.

Alternatively, a material that does not have conductivity out of the adhesive layer may not be provided at the location where the support 200 serving as the electrode terminal is coupled to the power generation element 110.

Nevertheless, the following problem may arise in the case where the support 200 is the electrode terminal.

As discussed earlier, the power generation element 110 expands in the positive direction of the Z-axis and the negative direction of the Z-axis along with the charge and discharge. As a consequence, the second plane 112 to be electrically coupled to the support 200 serving as the electrode terminal causes a deformation such as warpage. In this way, a coupling failure may occur between the power generation element 110 and the electrode terminal (the support 200), thus leading to current crowding and significant deterioration of the battery characteristics.

However, provision of the bent parts 221 relaxes the pressure to be applied to the electrode terminal (the support 200) attributed to the deformation such as the warpage of the power generation element 110. Thus, an influence of the coupling failure is reduced. Accordingly, it is possible to realize the battery 1000 with the power generation element 110 that is less likely to cause the current crowding. In other words, the battery 1000 having high reliability can be realized.

Note that the projection distance d3 of the support 200 from the second plane 112 is set preferably greater than or equal to 1 mm and less than or equal to 10 mm also in the case where the support 200 is the electrode terminal.

By setting the projection distance d3 greater than or equal to 1 mm as mentioned above, it is possible to relax the stress to be applied to the electrode terminal (the support 200), which may be generated in the case of the deformation (such as warpage) of the power generation element 110. Thus, it is possible to obtain a higher effect to suppress a coupling failure.

Meanwhile, setting the projection distance d3 less than or equal to 10 mm reduces the chance of the increase in size of the electrode terminal. Thus, it is possible to sufficiently suppress the increase in line resistance and to improve the battery characteristics.

In this embodiment, the second support body 220 is coupled to the negative electrode current collector 106. However, the present disclosure is not limited to this configuration. For instance, the first support body 210 may be coupled to one of the positive electrode layer and the negative electrode layer. In this case, any of the positive electrode layer and a member electrically coupled to the positive electrode layer is exposed to the first plane 111, and either the positive electrode layer or the member electrically coupled to the positive electrode layer may be coupled to the first support body 210 serving as the electrode terminal. The insulator 120 need not be provided in this case.

In this case, the first support body 210 may be in contact with the entire surface of the first plane 111.

By increasing the contact area between the first support body 210 serving as the electrode terminal and the power generation element 110 as described above, it is possible to prevent an increase in electronic resistance due to a coupling failure.

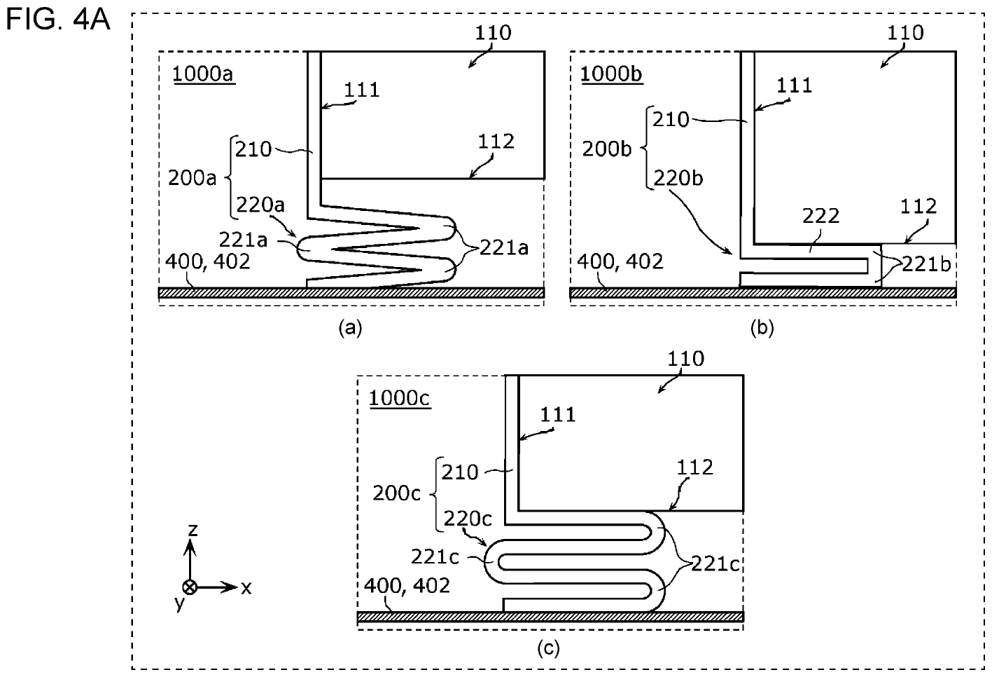

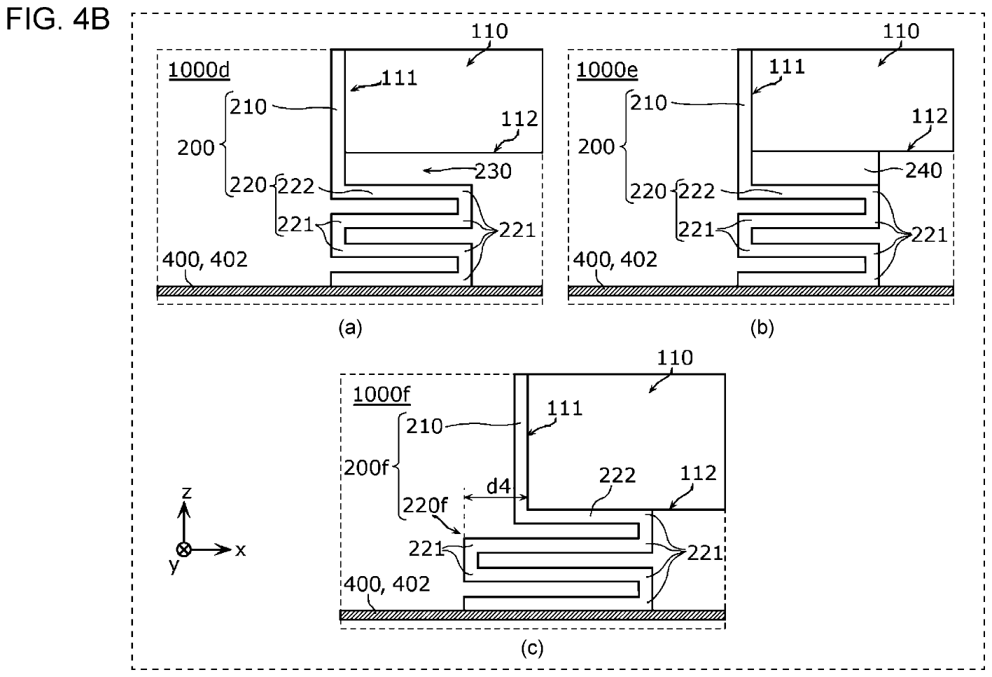

Next, a description will be given of modified examples of the embodiment. The embodiment has demonstrated the example in which the second support body 220 includes the parallel surface 222 and the multiple bent parts 221 each having the L-shape. However, the present disclosure is not limited to this configuration. Shapes of the second support bodies 220 of the following first to sixth modified examples are different from the shape of the second support body 220 of the embodiment. The batteries according to the first to sixth modified examples will be described with reference to FIG. 4A and 4B.

FIG. 4A illustrates side views of surrounding parts of the second support bodies provided to the batteries according to the first to third modified examples of the embodiment. FIG. 4B illustrates side views of surrounding parts of second support bodies provided to the batteries according to the fourth to sixth modified examples of the embodiment. FIGS. 4A and 4B are the side views of the batteries of the modified examples, which correspond to a region IV of the battery 1000 of the embodiment illustrated in FIG. 3A.

In the following modified examples, detailed explanations of the constituents common to those of the embodiment will be omitted.

### First Modified Example

FIG. 4A(a) is a diagram illustrating a surrounding part of a support 200a provided to a battery 1000a of the first modified example. The support 200a includes the first support body 210 and a second support body 220a provided with bent parts 221a . In this modified example, a sectional shape of each bent part 221a taken along a plane perpendicular to the first plane 111 and to the second plane 112 (that is, the ZX plane) includes a V-shape. As illustrated in FIG. 4A(a), a tip end of the V-shape may be an arc shape instead of a sharp-pointed shape.

Since the sectional shape includes the V-shape, the bent part 221a can exert a sufficient elastic force. Thus, it is possible to suppress the occurrence of detachment or cracks in the power generation element 110.

### Second Modified Example

FIG. 4A(b) is a diagram illustrating a surrounding part of a support 200b provided to a battery 1000b of the second modified example. The support 200b includes the first support body 210 and a second support body 220b provided with two bent parts 221b . In this modified example, a sectional shape of each bent part 221b taken along a plane perpendicular to the first plane 111 and to the second plane 112 (that is, the ZX plane) includes a L-shape.

Each bent part 221b can exert a sufficient elastic force even in the case of providing the two bent parts 221b. Thus, it is possible to suppress the occurrence of detachment or cracks in the power generation element 110.

### Third Modified Example

FIG. 4A(c) is a diagram illustrating a surrounding part of a support 200c provided to a battery 1000c of the third modified example. The support 200c includes the first support body 210 and a second support body 220c provided with bent parts 221c . In this modified example, a sectional shape of each bent part 221c taken along a plane perpendicular to the first plane 111 and to the second plane 112 (that is, the ZX plane) includes an U-shape. The second support body 220c may have a turned-back shape as illustrated in FIG. 4A(c).

Since the sectional shape includes the U-shape, the bent part 221c can exert a sufficient elastic force. Thus, it is possible to suppress the occurrence of detachment or cracks in the power generation element 110.

### Fourth Modified Example

FIG. 4B(a) is a diagram illustrating a surrounding part of a support 200 provided to a battery 1000d of the fourth modified example. The support 200 includes the first support body 210 and a second support body 220 provided with bent parts 221. Meanwhile, the second support body 220 may include the parallel surface 222.

The embodiment has described the example in which the second support body 220 (or the parallel surface 222 to be more precise) is in contact with the second plane 112. In this modified example, the second support body 220 is separated from the second plane 112. More specifically, the parallel surface 222 included in the second support body 220 is separated from the second plane 112. A separation space 230 is defined between the parallel surface 222 and the second plane 112.

For this reason, even when the power generation element 110 expands, the second plane 112 of the power generation element 110 does not come into contact with the second support body 220 and the second plane 112 is kept from receiving any pressure from the second support body 220. Thus, it is possible to suppress the occurrence of detachment or cracks in the power generation element 110.

In other words, provision of the above-described support body 200 makes it possible to support the power generation element 110 easily and to suppress the occurrence of detachment or cracks in the power generation element 110.

### Fifth Modified Example

FIG. 4B(b) is a diagram illustrating a surrounding part of a support 200 provided to a battery 1000e of the fifth modified example. The support 200 includes the first support body 210 and a second support body 220 provided with bent parts 221. Meanwhile, the second support body 220 may include the parallel surface 222. The battery 1000e of this modified example further includes a resin member 240 located between the second support body 220 and the second plane 112. To be more precise, the resin member 240 is located between the parallel surface 222 included in the second support body 220 and the second plane 112, and is in contact with the parallel surface 222 included in the second support body 220 and with the second plane 112. Thus, the second support body 220 supports the power generation element 110 through the resin member 240.

A shape of the resin member 240 is a rectangular parallelepiped. However, the shape of the resin member 240 is not limited to a particular shape as long as the resin member 240 can be located between and be in contact with the parallel surface 222 included in the second support body 220 and the second plane 112.

The resin member 240 is made of a resin material. The above-described materials to be used to the support 200 may be adopted as this resin material. However, the resin material is not limited to the foregoing. Alternatively, the resin material may adopt an elastomer material. The elastomer material is a material having elasticity. Examples of the elastomer material include thermosetting elastomers and thermoplastic elastomers. However, the elastomer material is not limited to the foregoing.

The second support body 220 supports the second plane 112 through the resin member 240 in addition to the support of the first plane 111 by the first support body 210.

Thus, the support 200 can support the power generation element 110 more easily.

A description will further be given of the case in which the resin member 240 is made of the elastomer material. Since the resin member 240 provides elasticity between the second plane 112 and the second support body 220, the pressure for supporting the power generation element 110 is less likely to be increased even in the case of the expansion of the power generation element 110. Thus, it is possible to suppress the occurrence of detachment or cracks in the power generation element 110.

### Sixth Modified Example

FIG. 4B(c) is a diagram illustrating a surrounding part of a support 200f provided to a battery 1000f of the sixth modified example. The support 200f includes the first support body 210 and a second support body 220f provided with bent parts 221. Meanwhile, the second support body 220 may include the parallel surface 222.

In this modified example, the support 200f projects from the first plane 111 in a direction opposite to the power generation element 110. A projection distance d4 is greater than or equal to 0.1 mm and less than or equal to 10 mm, for example. The direction opposite to the power generation element 110 from the first plane 111 is the negative direction of the X-axis.

As described above, the power generation element 110 is deformed in such a way as to extend mainly in the laminating direction, namely, in the positive direction of the Z-axis and the negative direction of the Z-axis. Nonetheless, the power generation element 110 is slightly deformed in such a way as to extend in a direction perpendicular to the laminating direction as well, namely, in the positive direction of the X-axis and the negative direction of the X-axis. In this regard, even when the power generation element 110 is deformed in such a way as to extend in the direction perpendicular to the laminating direction, the deformation of the power generation element 110 in the perpendicular direction is allowed by setting the projection distance d4 greater than or equal to 0.1 mm. As a consequence, the deformation of the power generation element 110 is relaxed and reliability of the battery 1000f is improved.

In the meantime, it is possible to embed the battery 1000f in a smaller region by further reducing the projection distance d4. For this reason, an increase in size of the battery 1000f is suppressed by setting the projection distance d4 less than or equal to 10 mm.

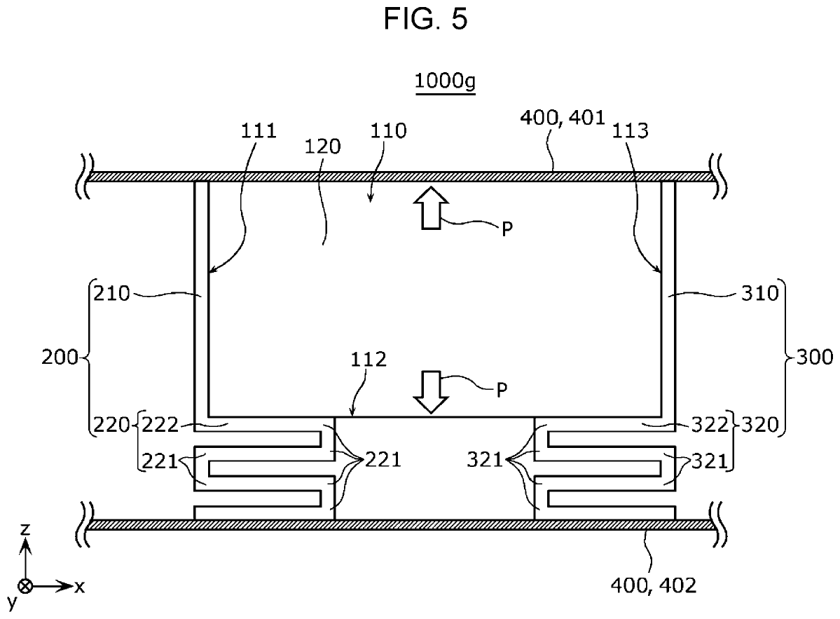

Now, a seventh modified example will further be described with reference to FIG. 5.

FIG. 5 is a side view illustrating a state in which a battery 1000g according to this modified example is housed in the housing 400.

The battery 1000g of this modified example includes the power generation element 110, a first support body, and a second support body 300. Note that the configuration of the first support body in this modified example is the same as the configuration of the above-described support body 200. Accordingly, the first support body will be hereinafter referred to as the first support body 200.

The second support body 300 is a member that supports the power generation element 110. The second support body 300 includes a first support body 310 and a second support body 320.

The first support body 310 included in the second support body 300 has the same configuration as the configuration of the first support body 210 included in the first support body 200. However, the first support body 310 is different from the first support body 210 only in that the first support body 310 is in contact with the third plane 113. In other words, the first support body 200 and the second support body 300 support the surfaces of the power generation element 110 which are opposed to each other, respectively.

Meanwhile, the second support body 320 included in the second support body 300 has the same configuration as the configuration of the second support body 220 included in the first support body 200. Specifically, the second support body 320 includes bent parts 321 and a parallel surface 322.

The first support body 200 and the second support body 300 support the first plane 111, the second plane 112, and the third plane 113. In this way, the first support body 200 and the second support body 300 can support the power generation element 110 more easily.

### Other Embodiments

The battery according to the present disclosure has been described above based on the embodiment and the respective modified examples. However, the present disclosure is not limited to the embodiment and the respective modified examples described above. The present disclosure also encompasses various other embodiments obtained by providing the embodiment with various modifications that the person skilled in the art can think of, and other embodiments constructed by combining selected constituents out of the embodiment and the respective modified examples.

In the seventh modified example, the first support body 200 and the second support body 300 support the surfaces of the power generation element 110 which are opposed to each other, respectively. However, the present disclosure is not limited to this configuration. For instance, the battery may include three or more supports. Meanwhile, the shape in plan view of the power generation element (that is, the shape of the power generation element viewed in the negative direction of the Z-axis) may be a rectangle. The three or more supports may support respective sides or angles of the rectangle that represents the shape in plan view of the power generation element.

In each of the embodiment and the respective modified examples, the battery includes the single power generation element. However, the present disclosure is not limited to this configuration. For instance, the battery may include two or more power generation elements. In this case, another power generation element that is different from the power generation element 110 may be provided on a positive side on the Z-axis of the power generation element 110 of the embodiment, for example. Meanwhile, a support may be provided between the power generation element 110 and the other power generation element.

In each of the embodiment and the respective modified examples, the second support body 220 is provided between the power generation element 110 and the bottom surface portion 402 of the housing 400. However, the present disclosure is not limited to this configuration. For instance, the second support body 220 may be provided between the power generation element 110 and the top surface portion 401 of the housing 400.

Meanwhile, as illustrated in FIG. 2, the power generation element 110 includes the battery cells 101 of a series-connected type having a structure in which the battery cells 101 are laminated such that the negative electrode current collector 106 of a certain battery cell 101 is coupled to the positive electrode current collector 105 of another battery cell 101 that is located adjacent in the laminating direction. However, the present disclosure is not limited to this configuration. The power generation element may be a laminated battery of a parallel-connected type having a laminated structure in which the battery cells 101 are laminated such that current collectors of the same polarity of the battery located adjacent to each other in the laminating direction are coupled to each other. Alternatively, the power generation element may be a laminated battery that combines the series connection and the parallel connection, in which current collectors of the same polarity of the battery of the series-connected type located adjacent to each other in the laminating direction are coupled to each other.

For example, in the above-described embodiment, the power generation element 110 is the power generation element of the series-connection type having the structure in which the battery cells 101 are laminated such that the electrode current collector of a certain battery cell 101 is coupled to a counter electrode current collector of another battery cell 101 that is located adjacent in the laminating direction. However, the present disclosure is not limited to this configuration. The power generation element may be a power generation element of a parallel-connection type having a laminated structure in which current collectors of the same polarity of the battery located adjacent to each other in the laminating direction are coupled to each other. Alternatively, the power generation element may be a power generation element that combines the series connection and the parallel connection, in which current collectors of the same polarity of the power generation element of the series-connected type are coupled to each other.

It is to be also noted that the above-described embodiment is subject to various changes, replacement, addition, omission, and the like within the scope of the appended claims or a range equivalent thereto.

### INDUSTRIAL APPLICABILITY

The battery of the present disclosure is applicable, for example, to a lithium ion secondary battery (such as an all-solid-state battery) and the like.

What is claimed is:

1. A battery comprising:
a power generation element that includes a positive electrode layer, a negative electrode layer, and an electrolyte layer which are laminated; and
a support that supports the power generation element, wherein
the power generation element includes:
a first plane that is a plane parallel to a laminating direction of the positive electrode layer, the negative electrode layer, and the electrolyte layer; and
a second plane that is a plane perpendicular to the laminating direction, and
the support includes:
a first support body that is in contact with the first plane; and
a second support body that includes a bent part which applies an elastic force to the power generation element in a direction perpendicular to the second plane.

2. The battery according to claim 1, wherein
the support is an electrode terminal, and
the support is coupled to one of the positive electrode layer and the negative electrode layer.

3. The battery according to claim 1, wherein
the second support body further includes a parallel surface that extends parallel to and along the second plane, and
the parallel surface is in contact with the second plane.

4. The battery according to claim 1, wherein the second support body is separated from the second plane.

5. The battery according to claim 1, further comprising a resin member located between the second support body and the second plane.

6. The battery according to claim 1, wherein the first support body is in contact with an entire surface of the first plane.

7. The battery according to claim 1, wherein the support projects from the second plane in a direction perpendicular to the second plane in an amount greater than or equal to 1 mm and less than or equal to 10 mm.

8. The battery according to claim 1, wherein the support projects from the first plane in a direction opposite to the power generation element in an amount greater than or equal to 0.1 mm and less than or equal to 10 mm.

9. The battery according to claim 1, wherein the support is formed from a plate member having a thickness greater than or equal to 50 μm and less than or equal to 5000 μm.

10. The battery according to claim 1, wherein the electrolyte layer is a solid electrolyte layer.

11. The battery according to claim 1, wherein
the power generation element includes a plurality of battery cells which are laminated, and
each of the battery cells includes the positive electrode layer, the negative electrode layer, and the electrolyte layer.

12. The battery according to claim 1, wherein a sectional shape of the bent part taken along a plane perpendicular to the first plane and to the second plane includes one of a U-shape, a V-shape, and an L-shape.
